(19) United States
(12) Patent Application Publication
(10) Pub. No.: US 2026/0030218 A1
(43) Pub. Date: Jan. 29, 2026

(54) DATA PROCESSING METHOD AND SYSTEM OPERATIG IN AN ENVIRONMENT WHERE INTERPLANETARY FILE SYSTEM IS APPLIED

(71) Applicants: YOUNGIL CHOI, Gyeonggi-do (KR); YONGHO KANG, Seoul (KR)

(72) Inventors: YOUNGIL CHOI, Gyeonggi-do (KR); YONGHO KANG, Seoul (KR)

(21) Appl. No.: 19/277,841

(22) Filed: Jul. 23, 2025

(30) Foreign Application Priority Data
Jul. 25, 2024 (KR) 10-2024-0098280

(51) Int. Cl. G06F 16/182; G06F 16/14

(52) U.S. Cl. CPC G06F 16/182; G06F 16/144

(57) ABSTRACT

The present invention discloses a data processing method and system operating in an environment where a decentralized distributed file storage system (InterPlanetary File System; IPFS) is applied. The data processing method includes a step of dividing each of at least one personalized data and distributing and storing them across IPFS nodes that are interconnected and synchronized via a network; a step of receiving query information of a processing request for data generation referencing the at least one personalized data through a generative artificial intelligence model; and a step of referencing the at least one personalized data from an IPFS node that is physically adjacent to a processing server operating the generative artificial intelligence model among the IPFS nodes, and generating response data corresponding to the query information.

### CROSS-REFERENCE TO RELATED APPLICATION

This application claims priority to and the benefit of Korean Patent Application No. 10-2024-0098280, filed on Jul. 25, 2024, the disclosure of which is incorporated herein by reference in its entirety.

### BACKGROUND

### 1. Field of the Invention

Various embodiments of the present invention relate to a data processing method and system operating in an environment where a decentralized distributed file system is applied, and more particularly, to a data processing method and system operating in an environment where a decentralized distributed file system is applied to process data using a generative artificial intelligence model.

### 2. Discussion of Related Art

In recent years, with the advancement of artificial intelligence technologies, various forms of AI models have been developed.

For example, representative AI models include machine learning models that learn patterns from data and make predictions or decisions on new data;

deep learning models that use multi-layer neural networks to learn complex patterns and structures; and

generative AI models that generate various types of content-such as text, images, and music-based on given data.

These artificial intelligence models commonly learn from large-scale data and, based on the learned data, respond immediately to user queries and process specialized algorithms. To do so, most of them have been implemented on centralized cloud servers.

However, existing centralized cloud servers, although capable of running the aforementioned AI models, have difficulty scaling when the number of users increases or when there is a surge in data, often resulting in system downtimes. Additionally, in the event of a power outage or system failure, the entire system may become inoperable, causing significant financial losses.

Furthermore, in existing centralized cloud servers, when massive volumes of data necessary for implementing AI models are concentrated, the risk of hacking or data leakage increases, presenting another significant problem.

Examples of the related art include Korean Registered Patent No. 10-2382379 (Registered date: Mar. 30, 2022)

### SUMMARY OF THE INVENTION

The present invention aims to address the aforementioned problems by providing a method and system for processing artificial intelligence data in an environment that combines a decentralized distributed file storage system and a generative artificial intelligence model.

According to one embodiment of the present invention, a data processing method for achieving the above-described objective relates to a data processing method for a data processing system operating in an environment utilizing a decentralized distributed storage file system (InterPlanetary File System; IPFS), wherein the data processing system includes a user terminal, IPFS nodes interconnected and synchronized via a network, and a processing server. The method includes dividing at least one of personalized data into a plurality of fragment files and distributing and storing the at least one of personalized data, including the plurality of fragment files, across the IPFS nodes, each of the plurality of fragment files having CID information allocated based on the personalized data before division, receiving query information for a processing request regarding data generation referencing the at least one of personalized data through a generative artificial intelligence model, and generating response data corresponding to the query information by referencing the at least one of personalized data from an IPFS node that is physically adjacent to the processing server on which the generative artificial intelligence model operates, among the IPFS nodes.

In one embodiment, the generative artificial intelligence model may be a large language model (LLM).

In one embodiment, the response data may be generated using a retrieval-augmented generation (RAG) technique.

In one embodiment, the method may further include inferring whether referencing the at least one of personalized data is required for generating the response data when the query information is received.

In one embodiment, the method may further include searching for an IPFS node that is physically adjacent to the processing server among the IPFS nodes when referencing the at least one of personalized data is required.

In one embodiment, when referencing a plurality of different personalized data is required according to the query information, for each of personalized data, an IPFS node that is physically adjacent to the server on which the generative artificial intelligence model operates, may be searched among the IPFS nodes where each of personalized data is stored.

In one embodiment, the storing may include generating fragmented files for each of the at least one personalized data based on a distributed hash table and distributing the fragmented files to the IPFS nodes.

In one embodiment, the distributed hash table may include CID information assigned to each personalized data before being divided into the fragmented files, dependent CID information assigned to each of the fragmented files, and node information of the IPFS nodes to which the fragmented files are distributed.

In one embodiment, may further include verifying a integrity of the data using the CID information before referencing the at least one of personalized data from the IPFS node that is physically adjacent to the processing server.

Also, a data processing system according to an embodiment for achieving the object of the present invention relates to a data processing system operating in an environment utilizing a decentralized distributed file storage system (InterPlanetary File System; IPFS). The data processing system includes an IPFS node server comprising IPFS nodes interconnected and synchronized via a network, configured to divide and store at least one of personalized data, and a processing server configured to receive query information for a processing request regarding data generation referencing the at least one of personalized data through a generative artificial intelligence model, and to generate response data corresponding to the query information by operating the generative artificial intelligence model, which references the at least one of personalized data from an IPFS node that is physically adjacent thereto, among the IPFS nodes of the IPFS node server.

As described above, various embodiments of the present invention have the effect of providing consistent and rapid data access performance to global AI users without network bottlenecks or data access bottlenecks, by utilizing synchronized and distributed AI data held by an IPFS node physically adjacent to a processing server on which the generative AI model operates, according to the user's location.

In addition, various embodiments of the present invention have the effect of further enhancing the security of AI data by operating the generative AI model through the distributed storage and encryption technologies of IPFS.

Furthermore, various embodiments of the present invention have the effect of greatly improving the reliability and availability of the entire system by utilizing a decentralized file system (IPFS) to reduce dependency on a centrally concentrated main server, thereby enabling data access even in the event of server failure. Accordingly, in the various embodiments of the present invention, since all nodes perform the same role without a central (main) node, network traffic overload problems can be resolved.

In addition, the various embodiments of the present invention can significantly reduce operating costs by preventing redundant storage through data fragmentation and efficiently utilizing storage space.

Moreover, the various embodiments of the present invention can improve transmission speed and greatly reduce network bottlenecks because data is directly transmitted to the user via the distributed network of the IPFS.

Furthermore, due to the decentralized architecture between IPFS and the generative AI model, the various embodiments of the present invention have the effect of ensuring that a failure in a specific node does not affect the entire system.

In addition, the various embodiments of the present invention enable the use of the cloud while maintaining data confidentiality by leveraging the IPFS (InterPlanetary File System) protocol to benefit from a closed system rather than an open one.

Moreover, the various embodiments of the present invention enable easy system scalability without additional server investment, even when the number of AI users increases, by utilizing the structure of IPFS.

In addition, the various embodiments of the present invention can reduce the costs of operating and managing a central server, and efficiently utilize resources required for data processing and storage.

The above-described effects are not limited thereto, and other effects not mentioned may be clearly understood by those of ordinary skill in the art from the following description.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram schematically illustrating a data processing system operating in an environment where a decentralized distributed file storage system and a generative artificial intelligence model are combined, according to an embodiment of the present invention.

FIG. 2 is a diagram schematically illustrating a network connection state of a plurality of IPFS nodes provided in an IPFS node server, which is a decentralized distributed file storage system according to an embodiment of the present invention.

FIG. 3 is a diagram schematically illustrating an implementation state of a plurality of processing servers according to an embodiment of the present invention.

FIG. 4 is a diagram schematically illustrating a configuration of a processing server for inferring whether to refer to personalized data, according to an embodiment of the present invention.

FIG. 5 is a diagram schematically illustrating a configuration of a processing server for verifying the integrity of personalized data according to an embodiment of the present invention.

FIG. 6 is a flowchart schematically illustrating a data processing method operating in an environment where a decentralized distributed file storage system and a generative artificial intelligence model are combined, according to an embodiment of the present invention.

FIG. 7 is a flowchart schematically illustrating a method for inferring whether to refer to personalized data according to an embodiment of the present invention.

FIG. 8 is a flowchart schematically illustrating a method for verifying the integrity of personalized data according to an embodiment of the present invention.

### DETAILED DESCRIPTION OF EXEMPLARY EMBODIMENTS

The embodiments described in this specification and the configurations shown in the drawings are merely exemplary implementations of the disclosed invention, and as of the filing date of this application, various alternative embodiments may exist to replace the described embodiments and drawings. In the drawings, the same reference numerals or symbols denote components or elements that perform substantially the same function.

Also, the suffix “-unit” used for components described in this specification is given or mixed merely for the convenience of drafting the specification, and does not inherently have a meaning or role that distinguishes one from another. Furthermore, the “-unit” may include units implemented by hardware, units implemented by software, or units implemented using both. A single unit may be implemented using two or more hardware components, and two or more units may be implemented by a single hardware component.

In this specification, expressions such as “A and/or B” and “at least one of A and B” shall be understood to include all possible combinations of the listed items. Also, terms including ordinal numbers, such as “first” and “second,” may be used to describe various components, but such components are not limited by these terms. These terms are used solely to distinguish one component from another.

In addition, terms such as “comprise” and “may comprise” used in this specification are intended to indicate the presence of features, numbers, steps, operations, components, parts, or combinations thereof as described in the specification, and do not preclude the presence or addition of one or more other features, numbers, steps, operations, components, parts, or combinations thereof.

Furthermore, the terminology used in this specification is merely for the purpose of describing particular embodiments and is not intended to limit the scope of other embodiments. Singular expressions may include plural meanings unless the context clearly indicates otherwise. All terms used herein, including technical and scientific terms, shall be interpreted in accordance with their commonly understood meaning by those of ordinary skill in the art to which this disclosure belongs. Terms that are generally defined in dictionaries shall be interpreted to have the same or similar meaning within the context of the relevant technology, and unless explicitly defined in this application, shall not be interpreted in an idealized or excessively formal sense. In some cases, even terms defined in this application shall not be interpreted as excluding the embodiments of the present disclosure.

Hereinafter, preferred embodiments of the present disclosure will be described in more detail with reference to the drawings.

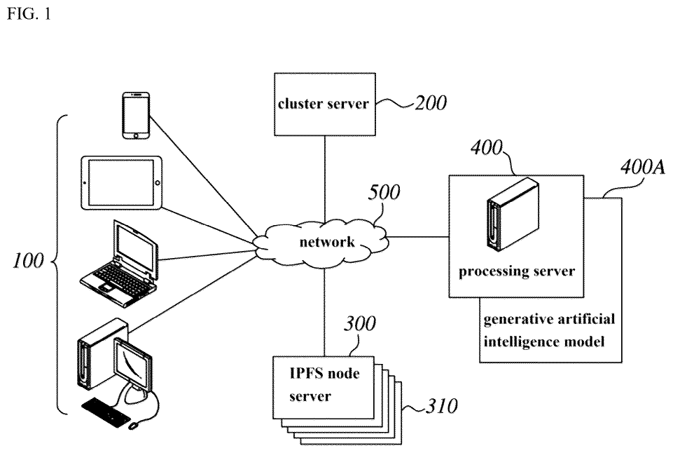

FIG. 1 is a diagram illustrating an example of a data processing system operating in an environment in which a decentralized distributed file storage system and a generative artificial intelligence model are combined according to an embodiment of the present invention.

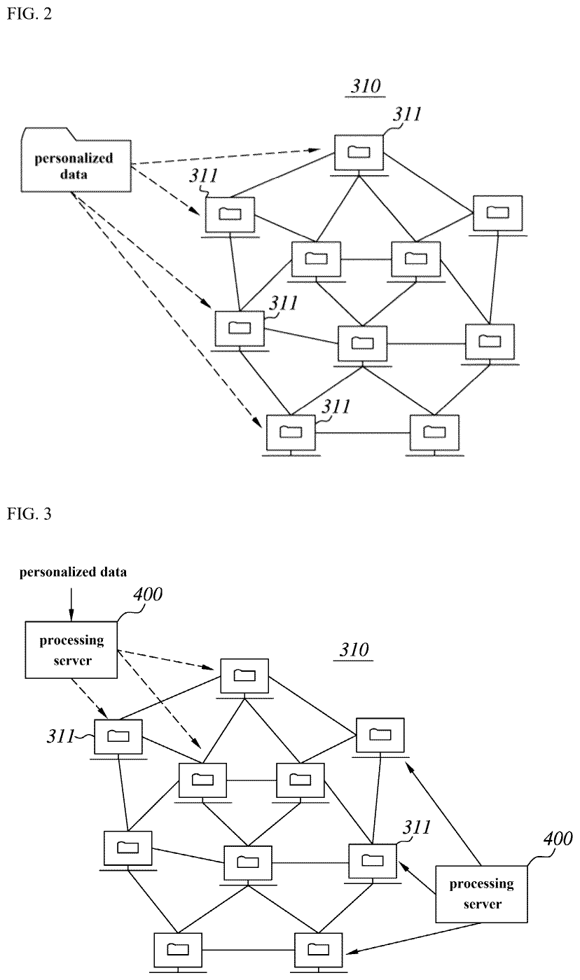

FIG. 2 is a diagram illustrating an example of the network connection state of a plurality of IPFS nodes included in an IPFS node server, which is a decentralized distributed file storage system according to an embodiment of the present invention.

FIG. 3 is a diagram illustrating an example of an implementation state of a plurality of processing servers according to an embodiment of the present invention.

Here, FIGS. 2 and 3 will be cited together when explaining FIG. 1.

Referring to FIG. 1, a data processing system according to an embodiment may include a user terminal (100), a cluster server (200), an IPFS node server (300), a processing server (400), and a network (500).

In one embodiment, the user terminal (100) may directly transmit personalized data generated for each user to the IPFS node server (300), to be described later, and store it in a distributed manner. Alternatively, the personalized data may be transmitted to a cluster server (200), also to be described later, such that the cluster server (200) distributes and stores the personalized data across the plurality of IPFS nodes (310) of the IPFS node server (300).

Meanwhile, the cluster server (200) may operate as a management server that performs data replication and distribution across the plurality of IPFS nodes (310), maintains continuous availability without service interruption in the event of a failure of a specific node, allocates data to prevent overloading on a specific node, and ensures data tracking and integrity. However, the present invention is not limited thereto, and the cluster server (200) itself may be omitted. In such a case, each of the plurality of IPFS nodes (310) may operate as a management server without a separate cluster server.

The personalized data mentioned herein may refer to personal data created or generated by each user either online or offline, or enterprise data related to corporate operations (such as medical data, healthcare data, content data, etc.), and may include data requiring security protection.

For example, the personal data may be data not related to a company but owned purely by individuals, such as personally identifiable information like the user's name, address, and contact information;

personal preference data reflecting the user's tastes, preferences, and interests;

online data that records user's online activity such as website visits, search history, and click data; and

user-generated content such as documents, photos, and videos. However, the invention is not limited thereto.

In contrast, enterprise data may refer to data generated by users affiliated with a company in relation to the company's operations, such as data accumulated and recorded in the process of conducting business activities. However, the present invention is not limited thereto. For example, personalized data should be understood to collectively refer to all data generated by both individual users and corporate users.

Such personalized data refers to data that must maintain security so as not to be disclosed online, regardless of whether it is generated by an individual user or a corporate user.

Accordingly, as described above, when the user terminal (100) generates personalized data that requires security maintenance, it may use IPFS client software to divide each of the generated personalized data and directly distribute and store it in the IPFS node server (300). That is, by using IPFS, which is a decentralized distributed file storage system, to store the data in a distributed manner, the risk of data leakage and hacking can be minimized. As a result, security issues that may arise in centralized systems can be addressed, and the confidentiality of the data can be maintained. In other words, IPFS ensures data availability even if some nodes go offline by storing the data in multiple locations.

In other words, the user terminal (100) may operate IPFS client software and, through the activated IPFS client, divide each of at least one of personalized data and distribute and store it across a plurality of IPFS nodes (310) of the IPFS node server (300), which are interconnected and synchronized via the network (500). Alternatively, with the help of the cluster server (200), each of personalized data may be divided and distributed for storage across a plurality of IPFS nodes (310) of the IPFS node server (300), which are interconnected and synchronized via the network (500).

Meanwhile, the network (500) may be implemented as either a public network or a private network. For example, in the case of a public network, the IPFS node server (300) operates as a public IPFS that is accessible by anyone. In this case, separate encryption processing may be performed to protect the personalized data.

In contrast, in the case of a private network, the system operates as a closed network accessible only to limited users, and the IPFS node server (300) may function as a private IPFS with restricted data access, thereby enhancing security and privacy. When applying a private network, it is possible to enjoy the advantages of a closed system that ensures data confidentiality by using the IPFS protocol while still utilizing the cloud.

In such a case, the aforementioned personalized data may be divided into multiple fragment files, for example, thousands to hundreds of millions of pieces, and each fragment file may have a unique CID (Content Identifier) generated in association with the original file.

For example, if 10 GB of personalized data is assumed to be composed of 10,000 fragment files each with 1 MB, the user terminal (100) may divide each 10 GB of personalized data into 10,000 fragment files and distribute and store them across the plurality of IPFS nodes (310) provided in the IPFS node server (300), or, with the help of the cluster server (200), divide the 10 GB of personalized data into 10,000 fragment files and distribute and store them across the plurality of IPFS nodes (310) of the IPFS node server (300), which are interconnected and synchronized via the network (500).

For example, assuming there are three IPFS nodes, each of personalized data containing 10,000 fragment files may be identically transmitted and stored across the first to third IPFS nodes. Accordingly, the first to third IPFS nodes will identically hold at least one of personalized data composed of 10,000 fragment files.

As a result, the processing server may search for a nearby IPFS node to retrieve the desired personalized data. Furthermore, in the event that any data is lost or partially altered due to a security issue among the IPFS nodes, it is possible to restore the original file by performing data integrity verification-such as garbage collection-based on the pinned CID information and retrieving the identical data from another adjacent IPFS node. That is, by utilizing the pinning and garbage collection features of IPFS technology, it is possible to respond to data corruption and ransomware attacks.

Meanwhile, the CID information refers to a unique identifier used in IPFS to identify and locate files or data fragments. It is one of the core concepts of IPFS and plays an important role in ensuring data integrity and preventing duplication. Since CID information is based on the hash value of the data, if the data is changed, a new CID is generated, thereby ensuring the integrity of the data.

Moreover, identical data shares the same CID, which prevents redundancy and enables efficient data storage. Users may control CIDs to manage their personalized data selectively. Selective access to personalized data associated with the user-owned CID is possible, enabling the data owner to manage and protect their data more efficiently.

To further explain integrity verification, the CID information corresponding to each fragment file acts as a type of address information based on hash data. If a file is modified or corrupted, the CID information also changes accordingly. Therefore, if even one of the multiple fragment files has a changed CID value, the original personalized data cannot be restored, making it easy to determine whether the data has been altered.

As such, when part of the data has been modified, the change can be readily detected. In addition, data integrity can be verified through the use of a Merkle DAG (Merkle Directed Acyclic Graph), which enables verification that each part of the interconnected data structure is correctly linked and unmodified. This verification can be performed by the cluster server or by each IPFS server, or alternatively by an integrity verification unit described later.

Meanwhile, the plurality of IPFS nodes in which the fragment files are stored may be selective. For example, if there are ten connected IPFS nodes, the fragment files may be stored in three of those nodes selectively.

Additionally, a corresponding compute server (not shown) may be connected to each IPFS node. The compute server may manage the fragment files stored in the storage of its corresponding IPFS node and may, in response to a request to output the original personalized data, combine multiple fragment files based on CID information, or, in response to a request to store original personalized data, generate multiple fragment files.

As described above, when the personalized data composed of fragment files is distributed and stored across a plurality of IPFS nodes (310) of the IPFS node server (300), the user terminal (100), upon receiving a query inputted by the user-relating to at least one of searching, retrieving, editing, or downloading the content of the personalized data stored across the plurality of IPFS nodes (310) of the IPFS node server (300)—may transmit the query information to the processing server (400) via the network (500), and may receive a corresponding response from the processing server (400).

Here, since each user may generate query information related to at least one of searching, retrieving, editing, or downloading the contents of personalized data that differs from user to user, the response information contains inference results that differ accordingly.

Meanwhile, in one embodiment, the user terminal (100) may internally include the aforementioned plurality of IPFS nodes (310). In such a case, the user terminal (100) may use IPFS client software to divide each of personalized data and distribute and store them across the plurality of IPFS nodes (310) embedded within it.

From this perspective, the user terminal (100) may also function as a server equipped with a plurality of IPFS nodes (310). Accordingly, a user may access their own server—the user terminal (100)—from another network-connected device and perform at least one operation among searching, retrieving, editing, or downloading the content of personalized data that is distributed and stored across arbitrary IPFS nodes (310).

As described above, the user terminal (100) according to one embodiment may serve as either a client terminal or a server terminal. The user terminal (100) may include at least one of the following devices capable of processing respective functions via wired or wireless communication: a personal computer (PC; e.g., desktop computer, laptop or notebook computer, tablet computer, etc.), a smartphone (e.g., iOS, Android, Windows Phone, etc.), a mobile phone or feature phone, a smart TV with internet connectivity, a wearable device, an Internet of Things (IOT) device, or a browser-based device. However, it is not necessarily limited to these examples.

In one embodiment, if the user terminal (100) does not directly perform the instruction for distributing personalized data using IPFS client software, the cluster server (200) may collect at least one of personalized data from the user terminal (100) after the user terminal (100) subscribes to a data distribution processing service. The cluster server (200) may then divide each collected of personalized data and distribute and store them across the plurality of IPFS nodes (310) of the IPFS node server (300), which are interconnected and synchronized via the network (500).

At this time, the method for dividing each of personalized data is the same as the previously described method regarding the chunked files of 10 GB personalized data.

Such a cluster server (200) is not a server that directly manages the IPFS node server (300), but rather a server that collaborates with multiple other servers to optimize data distribution and storage. Its role is simply to distribute and store the collected personalized data across the plurality of IPFS nodes (310) of the IPFS node server (300), which are interconnected and synchronized via the network (500).

As can be seen from the above, either the cluster server (200) or the user terminal (100) may serve as the entity that divides each of personalized data and distributes and stores it across the plurality of IPFS nodes (310) of the IPFS node server (300), which are interconnected and synchronized via the network (500).

In this case, either the cluster server (200) or the user terminal (100) may generate chunk files by dividing each of at least one of personalized data based on a distributed hash table and distribute them to the IPFS node server (300).

The distributed hash table may include CID information assigned per personalized data before being divided into chunk files, dependent CID information assigned per chunk file, and node information of the IPFS node server to which the data is distributed.

Such a distributed hash table may be used to identify and authenticate the corresponding IPFS node server, the corresponding IPFS node, the corresponding personalized data, and each chunk file of the personalized data.

While the distributed hash table can be used to distribute at least one of personalized data, it may also be utilized by the processing server (400), which will be described later.

In one embodiment, the IPFS node server (300) may be composed of a plurality of IPFS nodes (310) that store each of at least one of personalized data received from the user terminal (100) or the cluster server (200) after dividing it.

At this time, as shown in FIG. 2, the plurality of IPFS nodes (310) may have a network topology interconnected through a network. Due to this network topology, the plurality of IPFS nodes (310) may synchronize and distribute-store the personalized data received from the user terminal (100) or the cluster server (200), both connected via the network (500).

In such a case, even if a failure occurs in at least one of the plurality of IPFS nodes (310), as long as there is at least one specific IPFS node that has not failed and is synchronized, the at least one failed IPFS node (310) can replicate and possess the personalized data composed of a plurality of chunk files based on the CID information or dependent CID information from the available IPFS node.

As such, even if a failure occurs in some of the plurality of IPFS nodes (310), since the same personalized data can be replicated from a normal specific IPFS node (311) that is interconnected via the network, it can be said that the plurality of IPFS nodes (310) are synchronized with one another.

Meanwhile, the personalized data stored in the plurality of IPFS nodes (310) may be training data referenced by the generative AI model (400A), and may be updated and stored from time to time.

In one embodiment, the processing server (400) may receive query information regarding a data generation processing request that references at least one of personalized data through the generative AI model (400A) from the corresponding user terminal (100), or, if the user has generated the query information via another user terminal (not shown), the query information may be received from the other user terminal.

Accordingly, the processing server (400) may receive personalized data stored in a specific IPFS node (311) among the plurality of IPFS nodes (310) via the generative AI model (400A), and may generate response data to the user's query information by referencing the received personalized data in the generative AI model (400A) using CID information or dependent CID information. Alternatively, without receiving the personalized data stored in the specific IPFS node (311), the processing server (400) may directly reference the personalized data stored in the specific IPFS node (311) via the generative AI model (400A) using the CID information or dependent CID information, and generate response data to the user's query information based on the result.

In this case, the personalized data referenced in response to the user's query information may be inferred, and a response may be generated based on the inference result and provided to the corresponding user.

Meanwhile, as shown in FIG. 3, the processing server (400) may be composed of a plurality of processing servers, and among the plurality of processing servers (400), a specific processing server that is located closest to the location of the terminal (100, not shown) from which the query information originated may operate to receive the user's query information. If it is necessary to reference at least one of personalized data stored in one of the plurality of IPFS nodes (310) in response to the received query information, the specific processing server may search for a specific IPFS node (311) that is physically proximate among the IPFS node servers (310), reference at least one personalized data stored therein to derive an inference result, and generate and provide response data corresponding to the query information to the user based on the derived inference result.

For example, if the terminal generating the query information is located in the United States, Europe, or Asia, and a plurality of IPFS nodes (310) are distributed across a global network and interconnected through the distributed network, it can be assumed that a processing server (400) is connected to a specific IPFS node server that is physically proximate among the plurality of IPFS nodes (310). In this case, if user A located in the eastern United States generates query information to search for specific data, user B located in Western Europe generates query information to search for specific data, and user C located in the Asia-Pacific region generates query information to search for specific data, then user A's query information may be routed to a processing server located in the eastern United States (e.g., processing server A), user B's query information may be routed to a processing server located in Western Europe (e.g., processing server B), and user C's query information may be routed to a processing server located in the Asia-Pacific region (e.g., processing server C).

In this case, processing server A may identify the IPFS node located in the eastern United States (i.e., the IPFS node server in the eastern U.S.) that is physically proximate among the plurality of IPFS nodes (310) interconnected via the distributed network, and may generate response data based on inference results by referencing personalized data collected therefrom, and transmit the response data to user A's terminal. Similarly, processing server B may identify the IPFS node located in Western Europe that is physically proximate among the plurality of IPFS nodes (310) interconnected via the distributed network, and may generate response data based on inference results by referencing personalized data collected therefrom, and transmit the response data to user B's terminal. Likewise, processing server C may identify the IPFS node located in the Asia-Pacific region that is physically proximate among the plurality of IPFS nodes (310) interconnected via the distributed network, and may generate response data based on inference results by referencing personalized data collected therefrom, and transmit the response data to user C's terminal.

However, the operation of a specific processing server among the plurality of processing servers (400) is not necessarily limited to being based solely on the location of the closest terminal (100, not shown). For example, when all the processing servers (400) and all the IPFS nodes (310) are located in Korea, a processing server (400) situated between a user terminal in the United States and the plurality of IPFS nodes (310) may receive query information from the user terminal in the United States based on relative proximity, allowing for various alternative configurations. In such a case, once the corresponding processing server is activated, it references personalized data from a physically proximate specific IPFS node (311).

In any case, when the corresponding processing server is activated, it may generate response data corresponding to the query information based on the result obtained by referencing at least one personalized data stored in the physically adjacent IPFS node (311) among the IPFS node servers (300) interconnected via the distributed network, through the generative artificial intelligence model (400A), and transmit the response data to the terminal that generated the query information.

Here, the query information generated by the user, as mentioned earlier, may pertain to at least one of a search, retrieval, modification, or download of the content of personalized data. However, it is not limited thereto and may also be a query intended to obtain an inferred result regarding the content of the personalized data.

Accordingly, the query information may include a sentence-type statement intended to elicit the user's desired intent, and it may be an interactive query that exchanges information with the response data generated by the generative artificial intelligence model, like a chatbot.

Here, the generative artificial intelligence model (400A) described thus far is preferably a large language model (LLM) specialized in understanding and inferring the contents of a large volume of personalized data collected from a specific IPFS node (311) adjacent to the processing server (400).

Such a large language model may learn language patterns through billions of parameters derived from a large amount of personalized data and may perform various natural language processing (NLP) tasks. For example, the text data of the personalized data may be tokenized into tokens, each token may be converted into a high-dimensional vector, the relationships between the input tokens may be learned through multiple transformer layers, and the final vector obtained from the last layer may be converted back into text to generate response data.

Here, the generated response data may be created using a Retrieval-Augmented Generation (RAG) technique, which is one of various types of generative artificial intelligence models (400A).

For example, when a user enters a query such as “Show me the project plan I saved last week” to search their distributed personalized data, the corresponding processing server (400) may receive a query like “Summarize or organize the contents of the project plan saved last week.” In order to understand this, the Retrieval-Augmented Generation (RAG) technique may be used.

The Retrieval-Augmented Generation (RAG) model may analyze the contents of the query information and extract keywords such as “last week,” “project plan,” and “contents,” and may search for data matching those keywords from the adjacent specific IPFS node (311). In this process, the CID (Content Identifier) of the data may be used to quickly locate the distributed data, and the retrieved data may be inferred into a user-friendly format by the RAG model to generate response data.

For example, the RAG model may reference the personalized data and generate response data as an inference result, such as a summary of the project plan or a response organizing the main contents, which can then be provided to the terminal that issued the query information.

Meanwhile, the processing server (400) described above may reference the recovered personalized data if a failure occurs in a specific IPFS node (311) that is physically adjacent and connected among the plurality of IPFS nodes (310), as it remains synchronized with other normal IPFS nodes and stores the recovered personalized data.

Furthermore, the processing server (400) according to one embodiment may, depending on the query information, reference multiple personalized data sets stored across different IPFS node servers. In such a case, the generative AI model operating in response to the query may search for the IPFS node servers that are physically adjacent to each respective personalized data set stored in the plurality of IPFS node servers.

For example, when the processing server (400) receives query information from a user that requires referencing the data of both customer A and customer B, it may search for the IPFS nodes where each customer's personalized data is stored based on the received query information.

In this case, the processing server (400) may use the generative AI model to identify the physical locations of the IPFS nodes (310) where the personalized data of customer A and customer B are stored, and search for a specific IPFS node (311) that is physically proximate among the plurality of IPFS nodes (310) where customer A's data is stored. For example, if customer A's data is stored in Seoul, Busan, and Daejeon in Korea, the generative AI model may select the IPFS node (311) located in Seoul, which is the most accessible among them.

Additionally, the processing server (400) may search for a specific IPFS node (311) that is physically proximate among the plurality of IPFS nodes (310) where customer B's data is stored. For example, if customer B's data is stored in New York, San Francisco, and Chicago in the United States, the generative AI model may select the IPFS node (311) located in New York, which is the most accessible among them.

Accordingly, the processing server (400) according to one embodiment may reference customer A's personalized data from the specific IPFS node (311) located in Seoul and customer B's personalized data from the specific IPFS node (311) located in New York to generate response data corresponding to the query information. In this case, as previously mentioned, the response data is generated based on the inference results derived from the personalized data of each of customers A and B.

In this manner, the processing server (400) may reference and process different personalized data stored in a plurality of IPFS nodes (310) from respective physically adjacent IPFS nodes (311), thereby optimizing data access time, minimizing network traffic, and enabling efficient data processing.

Meanwhile, the processing server (400) according to one embodiment may further perform the personalized data distribution and storage function previously described with respect to the cluster server (200). In such cases, the cluster server (200) may be omitted. Accordingly, the processing server (400) may receive personalized data from the terminal that generated the query information and may divide each of the received personalized data using a distributed hash table to distribute and store them across a plurality of IPFS nodes (310) of the IPFS node server (300).

In one embodiment, the network (500) may include a wired or wireless network connection between any two components among the user terminal (100), the cluster server (200), the IPFS node server (300), and the processing server (400).

For example, when the network (500) is a wireless network, the wireless network may include at least one of LTE (Long-Term Evolution), LTE-A (LTE Advanced), CDMA (Code Division Multiple Access), WCDMA (Wideband CDMA), UMTS (Universal Mobile Telecommunications System), WiBro (Wireless Broadband), and GNSS (Global Navigation Satellite System).

On the other hand, when the network (500) is a wired network, the wired network may include at least one of a WAN (Wide Area Network), the Internet, and a telephone network. However, the types of the network (500) are not necessarily limited to these examples.

In contrast, the aforementioned short-range wireless communication may be one of Wi-Fi (Wireless Fidelity), Bluetooth, or NFC (Near Field Communication), and the short-range wired communication may be one of USB (Universal Serial Bus), HDMI (High-Definition Multimedia Interface), or RS-232 (Recommended Standard 232).

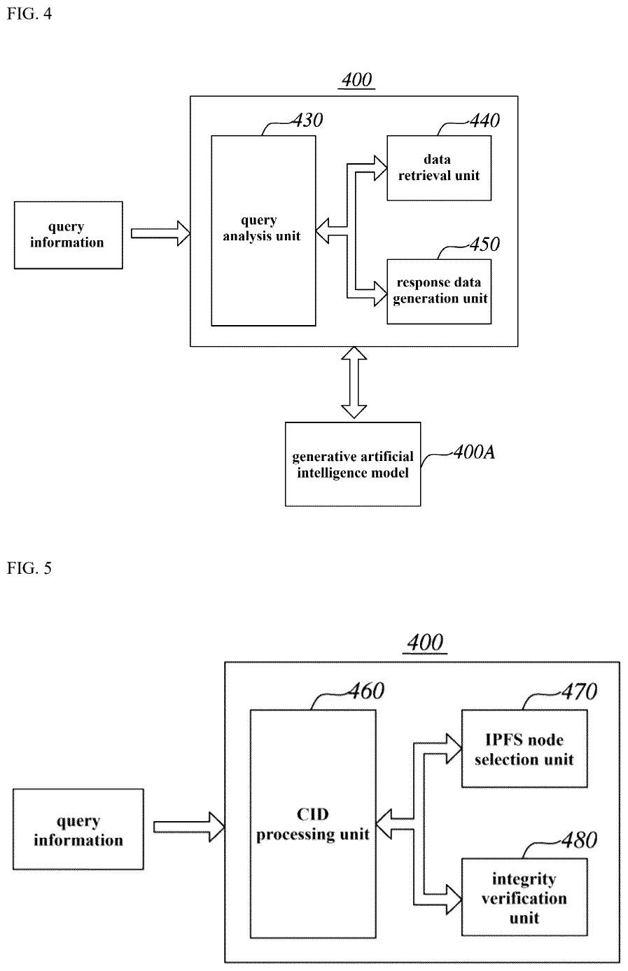

FIG. 4 is a diagram illustrating an example configuration of a processing server for inferring whether personalized data is to be referenced, according to an embodiment of the present invention.

Referring to FIG. 4, a processing server (400) according to an embodiment may include a query analysis unit (430), a data retrieval unit (440), and a response data generation unit (450).

In one embodiment, when the query analysis unit (430) receives query information from the terminal that generated the query, it may identify key keywords from the received query information using, for example, the natural language processing algorithm of the generative AI model (400A), and infer (or predict) the meaning of the identified keywords.

For example, the query analysis unit (430) may identify key keywords such as “last week,” “saved,” and “project plan” from a query such as “Show me the contents of the project plan saved last week.” It may infer that the expression “saved” indicates the need to access personalized data that was created or stored by the user. On the other hand, from a query such as “Show me the list of projects completed last week,” the query analysis unit may identify keywords such as “last week,” “completed,” and “project list,” and infer that the request pertains not to personalized data but to general organizational or team-related information.

Accordingly, in one embodiment, if the query analysis unit (430) determines that access to personalized data is required based on its inference, the data retrieval unit (440) may use the CID information or dependent CID information, which are unique identifiers of data, to retrieve at least one personalized data item stored in a physically proximate specific IPFS node (311), and search within the retrieved personalized data for content matching phrases like “project plan saved last week” or “projects completed last week.”

Thus, the response data generation unit (450) may generate response data by summarizing or extracting key content from the data retrieved by the data retrieval unit (440), and the generated response data may be provided to the user's terminal as a response to the query.

FIG. 5 is a diagram illustrating an example configuration of a processing server for verifying the integrity of personalized data, according to an embodiment of the present invention.

Referring to FIG. 5, the processing server (400) according to an embodiment may further include a CID processing unit (460), an IPFS node selection unit (470), and an integrity verification unit (480).

In one embodiment, the CID processing unit (460) may receive a query including the corresponding CID information from a user terminal (e.g., 100), or may receive only a query excluding the CID information as previously described.

Meanwhile, the IPFS node selection unit (470) may select a specific IPFS node (311) among the plurality of IPFS nodes (310) that is physically proximate, either based on the CID received by the CID processing unit (460), or by first checking the CID information in the query based on the distributed hash table, and then selecting the specific IPFS node (311) based on the checked CID information. Accordingly, the response speed can be improved.

In one embodiment, the integrity verification unit (480) may receive the CID information of the personalized data to be returned from the selected specific IPFS node (311) in order to refer to the personalized data stored therein, and may verify integrity by checking whether the received CID information matches the pre-stored CID information. Therefore, assuming that the data integrity is verified in this manner, the response data corresponding to the query information may be generated by referencing the personalized data.

For example, the integrity verification unit (480) may delete the file in the form of garbage collection if even a part of the fragment files becomes corrupted, causing the CID information to be changed. In some cases, garbage collection may automatically operate based on the inconsistency caused by a change in CID information as soon as any of the fragment files becomes corrupted. However, instead of unnecessarily activating garbage collection every time corruption occurs, it may be triggered when there is a request for output of the personalized data. Accordingly, there is no need to perform deletion and synchronization with other IPFS nodes due to garbage collection every time, and such operations can be performed only when necessary.

That is, after verifying integrity by checking for consistency between the information, based on the assumption that the data integrity has been verified, response data corresponding to the query information may be generated by referencing the corresponding personalized data.

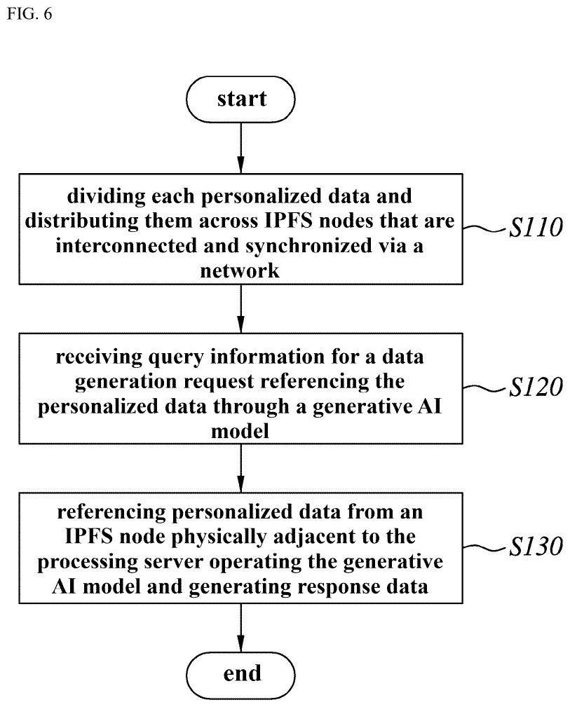

FIG. 6 is a flowchart illustrating an example of a data processing method operating in an environment in which a decentralized distributed file storage system and a generative artificial intelligence model are combined, according to an embodiment of the present invention.

Referring to FIG. 6, a data processing method according to an embodiment of the present invention may include steps S110 to S130 to process data operating in an environment in which a decentralized distributed file storage system (InterPlanetary File System; IPFS) and a generative artificial intelligence model are combined, by at least one processor among the user terminal (100), the cluster server (200), and the processing server (400).

In step S110, a processor of the user terminal (100) may divide each of at least one personalized data and store them in a distributed manner across a plurality of IPFS nodes (310) of an IPFS node server (300) that are interconnected and synchronized over a network. Alternatively, the processor may divide each personalized data with the assistance of a cluster server (200), and store them in a distributed manner across a plurality of IPFS nodes (310, which may be used interchangeably with multiple IPFS node servers) of the IPFS node server (300) that are interconnected and synchronized via the network (500).

In this case, the personalized data may be composed of a plurality of fragment files, and each fragment file may have its own unique CID information. For example, assuming that 10 GB of personalized data is composed of 10,000 fragment files of 1 MB each, the user terminal (100) may divide the 10 GB of personalized data into 10,000 fragment files and store them in a distributed manner across a plurality of IPFS nodes (310) provided in the IPFS node server (300). Alternatively, with the assistance of the cluster server (200), the 10,000 fragment files may be divided and stored in a distributed manner across a plurality of IPFS nodes (310) of the IPFS node server (300), which are interconnected and synchronized via the network (500).

For example, assuming there are three IPFS nodes, each personalized data comprising 10,000 fragment files may be identically transmitted to and stored in a first IPFS node to a third IPFS node. Accordingly, the first to third IPFS nodes will each hold the same set of 10,000 divided fragment files. Redundant explanations of the same content described above will be omitted.

As described above, when personalized data composed of fragment files is distributed and stored in the plurality of IPFS nodes (310) of the IPFS node server (300), the user terminal (100) may receive query information input by the user related to at least one of search, retrieval, modification, and data download of the contents of the personalized data distributed and stored in the plurality of IPFS nodes (310) of the IPFS node server (300), transmit the received query information to the processing server (400) through the network (500), and receive response information from the processing server (400) in response thereto.

Here, since each user generates query information related to at least one of search, retrieval, modification, and data download of the contents of different personalized data, the response information contains results inferred differently for each case.

Moreover, in step S110, the processor of the user terminal (100) may divide each personalized data using IPFS client software and distribute and store it in a plurality of IPFS nodes (310) provided internally.

From this perspective, the user terminal (100) may serve as a server equipped with a plurality of IPFS nodes (310), and therefore, the user may access their own server, i.e., the user terminal (100), from another terminal connected via a network and perform at least one of the operations of search, retrieval, modification, and data download for the contents of the personalized data distributed and stored in the arbitrary IPFS nodes (310).

Meanwhile, although it has been described above that each personalized data composed of fragment files is distributed across multiple nodes, for example, the 10,000 fragment files themselves may be divided and distributed across the plurality of IPFS nodes (310) for storage.

In step S120, the processor of the processing server (400) may receive query information for a data generation request that references at least one of personalized data through the generative artificial intelligence model (400A) from the corresponding user terminal (100), or, if the user has accessed through another user terminal (not shown) and generated the query information, the query information may be received from the other user terminal.

Here, preferably, when the processing server (400) is configured as a plurality of servers, a specific processing server closest in location to the terminal (100, not shown) from which the query information is generated among the plurality of processing servers (400) may operate to receive the user's query information.

In step S130, the processor of the processing server (400) may receive the personalized data stored in a specific IPFS node (311) by being connected to the specific IPFS node (311) among the plurality of IPFS nodes (310) through the generative artificial intelligence model (400A), and may generate response data for the user's query information by referencing the received personalized data in the generative artificial intelligence model (400A) using CID information or dependent CID information.

Alternatively, in step S130, the processor of the processing server (400) may generate response data for the user's query information by directly referencing the personalized data stored in the specific IPFS node (311) in the generative artificial intelligence model (400A) using CID information or dependent CID information, without receiving the personalized data from the specific IPFS node (311).

In this case, the personalized data referenced in response to the user's query information may be inferred, and response data may be generated based on the inference result and provided to the corresponding user.

Furthermore, in step S130, when referencing at least one personalized data stored in any one of the plurality of IPFS nodes (310) is required in response to the query information, the processor of the processing server (400) may search for a specific IPFS node (311, i.e., a specific IPFS node server) that is physically proximate among the IPFS node servers (310), and may derive an inference result by referencing the at least one personalized data stored in the searched specific IPFS node (311), and may generate response data corresponding to the query information based on the derived inference result and provide it to the corresponding user.

For example, assuming that the terminal generating the query information is located in the United States, Europe, or Asia, and that the plurality of IPFS nodes (310) are located across a globally distributed network, and a processing server (400) connected to a physically adjacent specific IPFS node among the plurality of IPFS nodes (310) interconnected via the distributed network exists, then if a user A located in the eastern United States generates query information to retrieve specific data, a user B located in western Europe generates query information to retrieve specific data, and a user C located in the Asia-Pacific region generates query information to retrieve specific data, the query information of user A may be routed to a processing server in the eastern United States (e.g., processing server A), the query information of user B may be routed to a processing server in western Europe (e.g., processing server B), and the query information of user C may be routed to a processing server in the Asia-Pacific region (e.g., processing server C).

In such a case, processing server A may search for an IPFS node located in the eastern United States (i.e., an IPFS node server in the eastern United States), which is physically proximate among the plurality of IPFS nodes (310) interconnected via the distributed network, and may generate response data based on the inference result referencing personalized data collected therefrom and transmit it to the terminal of user A. Processing server B may search for an IPFS node located in western Europe, which is physically proximate among the plurality of IPFS nodes (310) interconnected via the distributed network, and may generate response data based on the inference result referencing personalized data collected therefrom and transmit it to the terminal of user B. Processing server C may search for an IPFS node located in the Asia-Pacific region, which is physically proximate among the plurality of IPFS nodes (310) interconnected via the distributed network, and may generate response data based on the inference result referencing personalized data collected therefrom and transmit it to the terminal of user C.

However, the operation of a specific processing server among the plurality of processing servers (400) is not necessarily limited only by the location of the closest terminal (100, not shown). For example, when the plurality of processing servers (400) and the plurality of IPFS nodes (310) are all located in Korea, a processing server (400) located between a user terminal in the United States and the plurality of IPFS nodes (310) may receive query information from the user terminal in the United States, based on the distance between them, and various other modifications are possible. However, once the corresponding processing server operates, it references personalized data from a specific IPFS node (311) that is physically closest to it.

In any case, when the corresponding processing server operates, the processing server may generate response data corresponding to the query information based on the result referencing at least one personalized data stored in a specific IPFS node (311) that is physically proximate among the IPFS nodes (300) interconnected via the distributed network through the generative artificial intelligence model (400A), and transmit the response data to the terminal that generated the query information.

In this case, the query information generated by the user may relate to at least one of searching, retrieving, modifying, or downloading the contents of the personalized data, as mentioned earlier, but is not limited thereto, and may be a query intended to obtain an inference result regarding the contents of the personalized data.

Accordingly, the query information may include a sentence-type expression intended to elicit the user's intention, and may be a conversational query in which response data generated by a generative artificial intelligence model is interactively exchanged, like a chatbot.

Here, the generative artificial intelligence model (400A) described thus far is preferably a large language model (LLM) specialized in understanding and inferring the contents of a large volume of personalized data collected from a specific IPFS node (311) adjacent to the processing server (400).

Such a large language model may learn language patterns through billions of parameters of a large amount of personalized data and perform various natural language processing (NLP) tasks. For example, it may divide the text data of personalized data into tokens, convert each divided token into high-dimensional vectors, learn the relationships between input tokens through multiple transformer layers, and convert the vectors obtained from the final layer back into text to generate response data.

Alternatively, the generative artificial intelligence model may be a model that understands a user's request based on personalized data and responds to the request by fine-tuning a large language model (LLM) with training data that includes personalized data of a specific domain. For example, a pre-trained large language model such as GPT-3, BERT, or T5 may be prepared, and the selected model may be fine-tuned using the aforementioned training data. Specifically, the pre-trained language model may be fine-tuned using the designated domain or personalized data. In one embodiment, during fine-tuning, the model may be trained to generate appropriate responses to user requests. In this training process, a loss function is defined, and the accuracy of the model's predictions is evaluated based on how closely they match actual responses.

In this context, various metrics may be used to evaluate the performance of the artificial neural network model. In this embodiment, the performance is evaluated by calculating the F1 Score, which is the harmonic mean of precision and recall. The F1 Score is an indicator that reflects the balance between precision and recall and is particularly useful for imbalanced datasets.

Additionally, to visually evaluate the performance of the classification model, an AUC-ROC curve may be generated. The AUC-ROC curve is used to assess the classification performance of the model, and the closer the area under the ROC curve (AUC) is to 1, the better the model's performance is considered to be.

Furthermore, BLEU (Bilingual Evaluation Understudy) and ROUGE (Recall-Oriented Understudy for Gisting Evaluation) metrics may be used to evaluate the performance of the text generation model. BLEU and ROUGE objectively measure the quality of language generation models by evaluating text similarity based on n-grams.

In addition to merely evaluating the performance of the model, the interpretability of the model may also be assessed. To this end, SHAP (Shapley Additive Explanations) and LIME (Local Interpretable Model-agnostic Explanations) methods may be used. SHAP is a library that provides explanations for model predictions and evaluates the impact of each feature on the model's predictions by extracting SHAP values. Through SHAP, it is possible to understand which features the model relied on for its prediction.

The LIME method is used to explain the model's prediction for individual samples. LIME approximates the model in an interpretable form and calculates the importance of each feature, thereby explaining which features the model relied on to make a specific prediction.

Additionally, by analyzing the internal weights and bias values of the model, the influence of each feature variable can be estimated. This allows identification of the patterns learned by the model and the importance of each feature. To evaluate the model's practicality, human evaluation may also be conducted. Human evaluation assesses how actual users perceive and evaluate the model's output, providing a measure of the model's usability.

Meanwhile, the generated response data may be produced using the Retrieval-Augmented Generation (RAG) technique among various types of generative artificial intelligence models (400A). RAG is a technique that combines information retrieval and generative models, enabling the language model to utilize external knowledge bases. In one embodiment, RAG may be used to generate more accurate and useful responses. For this, text data is collected from various sources and stored in structured formats in a database or document repository. Then, request-response pairs from users are collected. The collected text data is refined by removing unnecessary expressions or special characters and is tokenized. Documents in the knowledge base are indexed to allow the search engine to quickly find relevant documents.

Subsequently, the RAG model is constructed. The RAG model may include a retriever model and a generator model. The retriever searches the knowledge base for documents relevant to the user's request, and the generator generates a final response based on the retrieved documents. In order to construct a system using a RAG model in one embodiment, a pre-trained language model is prepared. At this time, a pre-trained language model such as BERT or GPT-3 may be selected. Then, for fine-tuning the generator, the model may be trained using a dataset of user requests and response data.

Accordingly, for example, when a user wants to search personalized data stored in a distributed manner and inputs a query such as “Show me the contents of the project plan saved last week,” the corresponding processing server may receive a query such as “Summarize or display the contents of the project plan saved last week,” and may use the Retrieval-Augmented Generation (RAG) technique to understand the query.

The Retrieval-Augmented Generation (RAG) model may analyze the content of the query information to extract keywords such as “last week,” “project plan,” and “contents,” and may search the relevant IPFS node (311) located nearby for data matching the keywords. In this process, the CID (Content Identifier) of the data may be used to quickly locate distributed data, and the retrieved data may be inferred by the RAG model into a user-friendly form to generate response data.

For example, the RAG model may generate response data by inferring personalized data, such as by generating a summary of the project plan or organizing its main contents, and may provide the generated response data to the terminal that issued the query.

Meanwhile, in step S130, even if a failure occurs in a specific IPFS node (311) that is physically adjacent and connected among the plurality of IPFS nodes (310), the processor of the processing server (400) may still reference recovered personalized data because the nodes are synchronized with other functioning IPFS nodes, and the recovered personalized data may be stored.

Furthermore, in step S130, if the query information requires reference to multiple different personalized data stored in multiple IPFS node servers, the processor of the processing server (400) may use a generative AI model operating with such references to search, for each personalized data, the IPFS node (310) physically proximate to the corresponding IPFS node server where the data is stored.

For example, in step S130, when the processor of the processing server (400) receives query information from the corresponding user that requires referencing the data of customer A and customer B, the processor may search for the IPFS nodes in which each customer's personalized data is stored based on the received query information.

At this time, the processor of the processing server (400) may use a generative AI model to check the physical locations of the IPFS nodes in which the personalized data of customer A and customer B are stored, and may search for a specific IPFS node server that is physically adjacent among the IPFS node servers storing customer A's data. For example, if customer A's data is stored in Seoul, Busan, and Daejeon in Korea, the generative AI model may select the IPFS node (311) located in Seoul, which is the most easily accessible among them.

In addition, the processor of the processing server (400) may search for a specific IPFS node server that is physically adjacent among the IPFS nodes storing customer B's data. For example, if customer B's data is stored in New York, San Francisco, and Chicago in the United States, the generative AI model may select the specific IPFS node (311) located in New York, which is the most easily accessible among them.

Accordingly, in step S130, the processor of the processing server (400) may reference customer A's personalized data from the specific IPFS node located in Seoul, and reference customer B's personalized data from the specific IPFS node located in New York, and generate response data corresponding to the query information. In this case, the response data is, as previously described, generated based on the inference results of the personalized data of customers A and B, respectively.

The processor of the processing server (400), which performs such processing, may reference multiple different personalized data stored in a plurality of IPFS nodes (310), each from a physically adjacent specific IPFS node (311), and through this, optimize data access time, minimize network traffic, and perform efficient data processing.

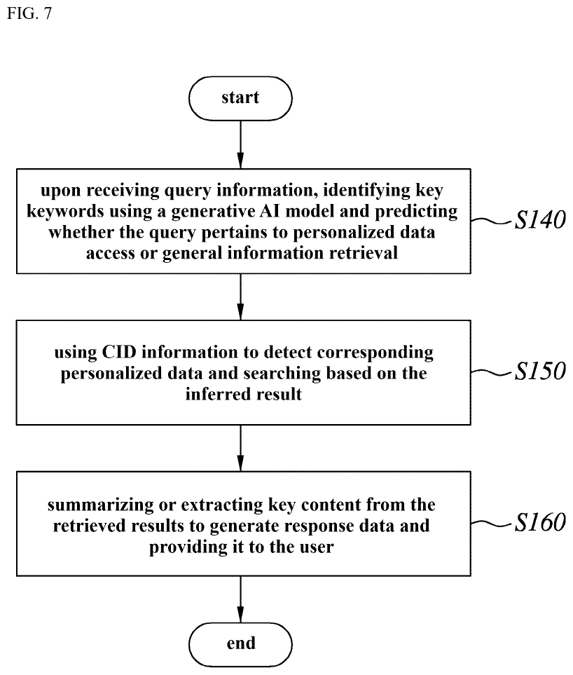

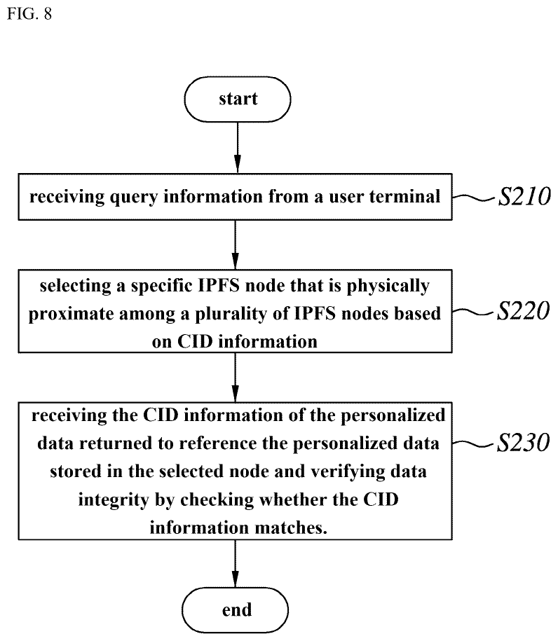

FIG. 7 is a flowchart exemplarily illustrating a method for inferring whether personalized data is to be referenced according to one embodiment of the present invention.

Referring to FIG. 7, the method according to one embodiment may further include steps S140 through S160, which are performed by the processor of the processing server (400), for inferring whether personalized data is to be referenced. In step S140, when the processor of the processing server (400) receives query information from the terminal (e.g., 100) that generated the query information, the processor may identify key keywords from the received query information using a generative AI model (400A), such as a natural language processing algorithm, and may infer (predict) the meaning of the identified keywords.

For example, the processor of the processing server (400) may identify key keywords such as “last week,” “saved,” and “project plan” from the query information “Show me the contents of the project plan saved last week.” The processor may infer that the expression “saved” indicates the need to access personalized data that the user has directly created or stored.

Alternatively, in step S140, the processor of the processing server (400) may identify keywords such as “last week,” “completed,” and “project list” from the query information “Show me the list of projects completed last week,” and may infer that the identified keywords relate not to personalized data access but to a general information inquiry regarding an organization or team.

As such, in step S140, it is possible to predict whether the user's query information is a request for general information retrieval or a request that requires access to personalized data.

In step S150, if the processor of the processing server (400) determines, based on the inference (prediction) result of step S140, that access to personalized data is necessary, it may detect at least one personalized data item stored in a physically adjacent specific IPFS node (311) using the CID information or dependent CID information, which is a unique identifier of the personalized data, and may search for data such as “project plan saved last week” or “projects completed last week” within the detected personalized data.

Accordingly, in step S160, the processor of the processing server (400) may summarize or extract the important content from the result retrieved in step S150, and generate response data, which may then be provided to the terminal that generated the query information as a response to the query.

FIG. 8 is a flowchart exemplarily illustrating a method for verifying the integrity of personalized data according to one embodiment of the present invention.

Referring to FIG. 8, the method according to one embodiment of the present invention may further include steps S210 through S230 in order to verify the integrity of personalized data, performed by the processor of the processing server (400).

In step S210, the processor of the processing server (400) may receive query information including corresponding CID information from a terminal (e.g., 100) of an arbitrary user, or may receive only the previously described query information without the CID information.

Then, in step S220, based on the CID received in step S210, the processor of the processing server (400) may select a specific IPFS node (311) located physically proximate among the plurality of IPFS nodes (310), or may confirm the CID information of the query using a distributed hash table and, based on the confirmed CID information, select a specific IPFS node (311) located physically closest among the plurality of IPFS nodes (310).

Subsequently, in step S230, the processor of the processing server (400) may receive the CID information of the returned personalized data from the specific IPFS node (311) selected in step S220 in order to reference the personalized data stored therein, and verify data integrity by checking whether the received CID information matches the CID information held in advance.

Accordingly, once data integrity is verified in this manner, response data corresponding to the query information is generated by referencing the relevant personalized data.

Meanwhile, the processor of the processing server (400) described above for performing the aforementioned data analysis and/or processing may include at least one core and may comprise a central processing unit (CPU), graphics processing unit (GPU), or a tensor processing unit (TPU). However, it is not necessarily limited thereto.

In addition, as described above, the functional operations of each component described according to various embodiments may be implemented in the form of program instructions and may be recorded on a computer-readable recording medium and/or memory.

The computer-readable recording medium mentioned may include program instructions, data files, data structures, or a combination thereof. f. The program instructions recorded on the computer-readable recording medium may be those specifically designed and configured for the present invention or may be those known and available to those skilled in the field of computer software. Examples of the computer-readable recording medium include magnetic media such as hard disks, floppy disks, and magnetic tapes, optical recording media such as CD-ROMs and DVDs, magneto-optical media such as floptical disks, and hardware devices specially configured to store and execute program instructions such as ROM, RAM, and flash memory. Examples of program instructions include not only machine code such as that generated by compilers, but also high-level language code that can be executed by a computer using interpreters, etc. The hardware device may be configured to operate as one or more software modules to perform the processing according to the present invention, and vice versa.

The term “model” in this specification may refer to any form of computer program that operates based on network functions, artificial neural networks, and/or neural networks. Throughout this specification, the terms “model,” “neural network,” “network function,” and “neural network” may be used interchangeably. A neural network is formed by one or more nodes interconnected via one or more links, creating input-output node relationships within the network. The characteristics of the neural network may be determined by the number of nodes and links within the network, the relationships among nodes and links, and the weights assigned to each link. The neural network may be composed of a set of one or more nodes, and a subset of the nodes may constitute a layer.

A deep neural network (DNN) may refer to a neural network that includes multiple hidden layers in addition to an input layer and an output layer. A deep neural network may include a convolutional neural network (CNN), a recurrent neural network (RNN), an autoencoder, a restricted Boltzmann machine (RBM), a deep belief network (DBN), a Q-network, a U-network, a Siamese network, a generative adversarial network (GAN), a transformer, and the like. The foregoing examples of deep neural networks are illustrative only and are not intended to limit the present disclosure.

The neural network may be trained using at least one of supervised learning, unsupervised learning, semi-supervised learning, self-supervised learning, or reinforcement learning. Training of the neural network may be a process of applying knowledge to the network to perform a specific task.

The neural network may be trained in a direction that minimizes output error. In neural network training, training data is repeatedly input to the network, the error between the network output and the target is calculated, and the error is backpropagated from the output layer to the input layer to update the weights of each node in the network. In the case of supervised learning, labeled data is used in which correct answers are labeled for each of training data, whereas in unsupervised learning, unlabeled data without correct answer labels is used. The weight update amount of each node may be determined according to a learning rate. The computation of the input data and the backpropagation of errors may constitute an epoch of training. The learning rate may vary depending on the number of epochs. To prevent overfitting, methods such as increasing training data, regularization, dropout of some nodes, and the use of batch normalization layers may be applied.

In one embodiment, the model may incorporate at least a portion of a transformer. The transformer may be configured to include an encoder that encodes embedded data and a decoder that decodes the encoded data. The transformer may have a structure that receives a sequence of data and outputs a different type of data sequence through encoding and decoding steps. In one embodiment, the sequence of data may be processed into a form that the transformer can operate on. The process of converting the sequence of data into a format operable by the transformer may include an embedding process. Terms such as data tokens, embedding vectors, and embedding tokens may refer to data embedded in a form that can be processed by the transformer.

In order for the transformer to encode and decode a sequence of data, the encoder and decoder within the transformer may be processed using an attention algorithm. The attention algorithm may refer to an algorithm in which, for a given query, the similarity to one or more keys is calculated, the calculated similarity is reflected in the values corresponding to each key, and the attention value is obtained by computing a weighted sum of the similarity-reflected values.

Depending on how the query, key, and value are set, various types of attention algorithms may be categorized. For example, when the query, key, and value are all set to be identical for calculating attention, it may refer to a self-attention algorithm. To process an input sequence of data in parallel, the embedding vector may be reduced in dimension, and separate attention heads may be computed for each segmented embedding vector to perform attention. This may be referred to as a multi-head attention algorithm.

In one embodiment, the transformer may be configured with modules that perform multiple multi-head self-attention algorithms or multi-head encoder-decoder algorithms. In one embodiment, the transformer may also include additional components that are not attention algorithms, such as embedding, normalization, and softmax. A method of configuring a transformer using an attention algorithm may include the method disclosed in Vaswani et al., Attention Is All You Need, NIPS 2017, which is incorporated herein by reference.

The transformer may be applied to various data domains such as embedded natural language, segmented image data, and audio waveforms, and may convert a sequence of input data into a sequence of output data. To convert data from various data domains into a sequence of data that can be input to the transformer, the transformer may embed the data. The transformer may process additional data that represents the relative positional or phase relationship among the sequence of input data. Alternatively, vectors representing the relative positional or phase relationships among the input data may be additionally reflected in the embedding of the sequence of input data. For example, the relative positional relationships among the sequence of input data may include word order in a natural language sentence, relative positional relationships among segmented images, or temporal order of segmented audio waveforms; however, they are not limited thereto. The process of adding information representing the relative positional or phase relationships among the sequence of input data may be referred to as positional encoding.

In one embodiment, the model may include at least one of a Recurrent Neural Network (RNN), a Long Short Term Memory (LSTM) network, a Deep Neural Network (DNN), a Convolutional Neural Network (CNN), and a Bidirectional Recurrent Deep Neural Network (BRDNN), but is not limited thereto.

In one embodiment, the model may be a model trained using a transfer learning method. Here, transfer learning refers to a learning method in which a pre-trained model for a first task is obtained by pre-training using semi-supervised learning or self-supervised learning on a large amount of unlabeled training data, and the pre-trained model is fine-tuned for a second task using supervised learning on labeled training data to implement a target model.

While the above has been described with reference to the specific embodiments and drawings limited to certain components such as the specific configurations according to various embodiments of the present disclosure, this is merely for better overall understanding and is not intended to limit the various embodiments. It will be apparent to those skilled in the art to which the present invention pertains that various modifications and changes can be made from these embodiments.

Accordingly, the technical spirit described in the present invention should not be construed as being limited to the embodiments described above, and all modifications equivalent or corresponding to the claims set forth below are considered to fall within the scope of the spirit of the present invention.

What is claimed is:

1. A data processing method for a data processing system operating in an environment utilizing a decentralized distributed storage file system (InterPlanetary File System; IPFS), wherein the data processing system includes a user terminal, IPFS nodes interconnected and synchronized via a network, and a processing server, the method comprising:
dividing at least one of personalized data into a plurality of fragment files and distributing and storing the at least one of personalized data, including the plurality of fragment files, across the IPFS nodes, each of the plurality of fragment files having CID information allocated based on the personalized data before division;
receiving query information for a processing request regarding data generation referencing the at least one of personalized data through a generative artificial intelligence model; and
generating response data corresponding to the query information by referencing the at least one of personalized data from an IPFS node that is physically adjacent to the processing server on which the generative artificial intelligence model operates, among the IPFS nodes.

2. The data processing method according to claim 1, wherein the generative artificial intelligence model is a large language model (LLM).

3. The data processing method according to claim 1, wherein the response data is generated using a retrieval-augmented generation (RAG) technique.

4. The data processing method according to claim 1, further comprising:
inferring whether referencing the at least one of personalized data is required for generating the response data when the query information is received.

5. The data processing method according to claim 4, further comprising:
searching for an IPFS node that is physically adjacent to the processing server among the IPFS nodes when referencing the at least one of personalized data is required.

6. The data processing method according to claim 5, wherein, when referencing a plurality of different personalized data is required according to the query information, for each of personalized data, an IPFS node that is physically adjacent to the server on which the generative artificial intelligence model operates, is searched among the IPFS nodes where each of personalized data is stored.

7. The data processing method according to claim 1, wherein the storing the at least one of personalized data comprises:
generating fragmented files for each of the at least one personalized data based on a distributed hash table and distributing the fragmented files to the IPFS nodes.

8. The data processing method according to claim 7, wherein the distributed hash table comprises CID information assigned to each personalized data before being divided into the fragmented files, dependent CID information assigned to each of the fragmented files, and node information of the IPFS nodes to which the fragmented files are distributed.

9. The data processing method according to claim 1, further comprising:
verifying a integrity of the data using the CID information before referencing the at least one of personalized data from the IPFS node that is physically adjacent to the processing server.

10. A data processing system operating in an environment utilizing a decentralized distributed file storage system (InterPlanetary File System; IPFS), comprising:
an IPFS node server comprising IPFS nodes interconnected and synchronized via a network, configured to divide and store at least one of personalized data; and
a processing server configured to receive query information for a processing request regarding data generation referencing the at least one of personalized data through a generative artificial intelligence model, and to generate response data corresponding to the query information by operating the generative artificial intelligence model, which references the at least one of personalized data from an IPFS node that is physically adjacent thereto, among the IPFS nodes of the IPFS node server.
